(19) United States
(12) Patent Application Publication
(10) Pub. No.: US 2005/0017184 A1
(43) Pub. Date: Jan. 27, 2005

(54) Apparatus and method to acquire images with high-energy photons

(76) Inventors: Burkhard Groh, Hoffman Estates, IL (US); Volker Heer, Gundelsheim (DE); Mathias Hornig, Erlangen (DE); Bernhard Sandkamp, Erlangen (DE)

Correspondence Address: SCHIFF HARDIN LLP;Patent Department, 6600 Sears Tower, 233 South Wacker Drive, Chicago, IL, 60606, US

(21) Appl. No.: 10/854,949

(22) Filed: May 27, 2004

(30) Foreign Application Priority Data
Jun. 4, 2003 (DE) 103 25 337.8

(51) Int. Cl. G01T 1/20

(52) U.S. Cl. 250/367

(57) ABSTRACT

In an apparatus and method to acquire Images with the aid of high-energy photons for the examination soft tissue parts, two x-ray exposures are simultaneously obtained in different energy ranges. At least two scintillators that transmit optical photons to associated detectors are disposed in the beam path of the x-ray photons.

### BACKGROUND OF THE INVENTION

1. Field of the Invention

The present invention concerns an apparatus to acquire images with high-energy photons, of the type having a detector region acquiring images, with at least two radiation energy converters disposed In the beam path of the high-energy photons that act on the photons in different high-energy ranges and that transmit photons in the low-energy range to respective detector regions associated with the radiation energy converters.

2. Description of the Prior Art

An apparatus of the above type is known from U.S. Pat. No. 4,963,746.

From U.S. Pat. No. 6,343,111, it is known to x-ray (transirradiate) the body part to be examined of a patient with x-ray light at different energy ranges. Initially a first exposure with x-ray radiation is implemented at a first energy level, and then a second exposure is implemented with x-ray radiation at a second energy level, The second energy level is below the first energy level. Both exposures are acquired in digital form, and the data of both exposures are subtracted from one another in a complex image processing method.

The known apparatuses serve to acquire x-ray images of soft parts of a patient. For example, it can be of interest to examine the lungs of a patient for lung cancer. The classical x-ray technique is not suitable means for this, because the image of the bone structure of the ribcage dominates the x-ray image. By the acquisition of two images in different energy ranges of the x-ray radiation and a subsequent subtraction of the brightness values, it is in principle possible to eliminate the bone structures from the image, such that a high-detail and high-contrast image of the soft tissue of the patient results in the final image.

A disadvantage of the known method and apparatus is that a movement of the patient between the two acquisitions can not be prevented due to the respiration and heartbeats. The movement effects must therefore be eliminated by a mathematically complex Image processing method. Shadows that can lead to artifacts in the finished image also enter in part into the image processing.

### SUMMARY OF THE INVENTION

An object of the present invention is to provide an apparatus and a method of the above general type with which soft parts of a patient can be acquired in a simple manner.

The above object is achieved in accordance with the present invention by an apparatus for acquiring images using high-energy photons, having a detector region for acquiring the images and at least two radiation energy transducers disposed in a beam path of the high-energy photons for differently interacting with the photons in different high-energy ranges, for transmitting photons in a lower of said high-energy ranges to a portion of said detector region. The radiation energy transducers have respectively different spectral distributions for the photons in the lower of the high-energy ranges. The detector region has different areas thereof that respectively have a sensitivity tuned to the respective spectral distributions.

In the inventive apparatus, the radiation energy converters with different spectral distributions for the emitted photons In the low-energy range are disposed in the beam path in front of a detector having a detector surface that is energy-selective. The radiation energy transducer arranged in front of the detector convert the photons in different high-energy ranges into photons in different low-energy ranges and transmit these to the detector, where they are detected by respectively associated energy-selective regions

Two exposures thus can simultaneously be made in different energy ranges with the apparatus, Since both exposures are implemented simultaneously, the movement of the patient plays no role in the subsequent subtraction of the two images. Complex image processing methods to compensate the motion of the patient are not needed in the inventive apparatus and the method.

An advantage of this embodiment is that only a single detector is necessary to acquire images in different energy ranges. The resolution of the acquired images in the respective energy ranges is lower in comparison to an apparatus with a number of detectors.

### DESCRIPTION OF THE DRAWINGS

FIG. 1 illustrates a first exemplary embodiment of an apparatus to acquire images in different high-energy ranges in accordance with the invention.

FIG. 2 illustrates a second exemplary embodiment of an apparatus to acquire images in different high-energy ranges in accordance with the invention,

FIG. 3 is a view from the front of a detector for the apparatus from FIG. 2.

FIG. 4 is a further view from the front of a further exemplary embodiment of a detector for the apparatus from FIG. 2.

FIG. 5 illustrates a third exemplary embodiment of an apparatus to acquire images in different high-energy ranges in accordance with the invention.

### DESCRIPTION OF THE PREFERRED EMBODIMENTS

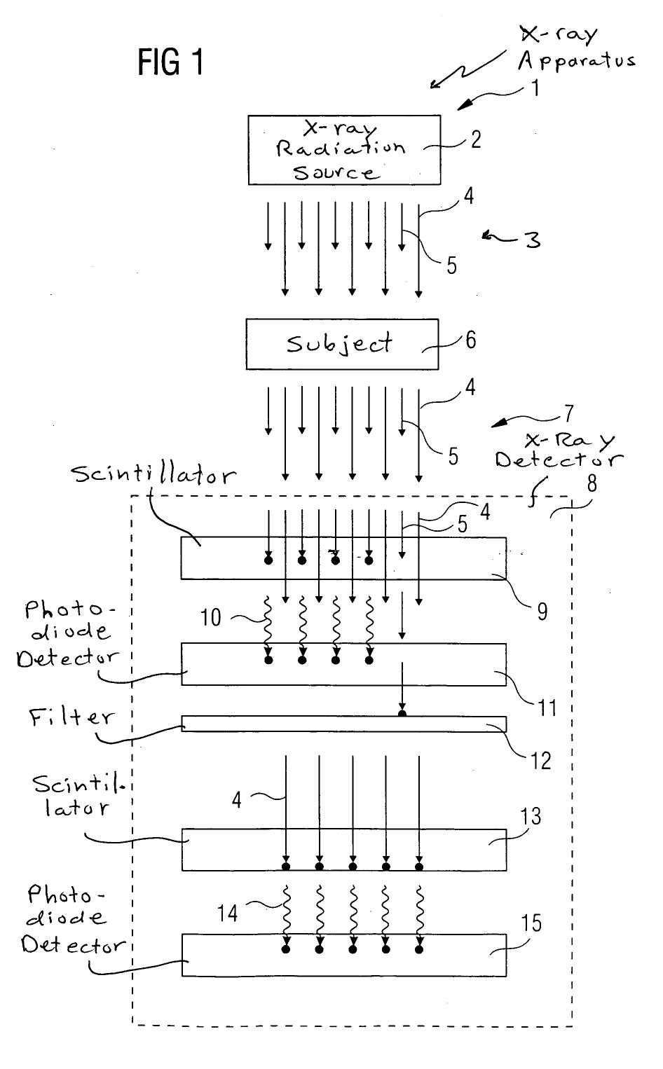

In FIG. 1, an x-ray apparatus is shown having x-ray radiation source 2 that emits x-ray radiation in different energy ranges in an x-ray pulse 3. For simplicity, in FIG. 1 only high-energy x-ray photons 4 and low-energy x-ray photons 5 are illustrated by arrows of different lengths. The terms “high-energy” and “low-energy” distinguish the relative energy levels of the respective x-ray photons from one another. The energies of “high-energy” x-ray photons are in an energy range above the energy of “low-energy” photons.

The x-ray pulse 3 is incident on a subject 6 to be examined, for example a body part of a patient, Depending on the structure of the subject 6, the high-energy photons 4 and the low-energy photons 5 in the x-ray pulse 3 are absorbed, and a shadow image of the absorption structure of the subject 6 is obtained from attenuated x-ray projections 7 penetrating the subject 6.

The attenuated x-rays 7 of the pulse 3 strike an x-ray detector 8 that has a scintillator 9 on the input side. The low-energy x-ray photons 5 are mostly absorbed in the scintillator 9. Upon absorption of an x-ray photon, the scintillator 9 emits optical photons 10 in an optical wavelength range that can be detected by a photodiode detector 11. The photodiode detector 11 is, for example, a detector in which a number of photodiodes made from amorphous silicon are arranged next to one another in an image area.

While the low-energy x-ray photons 5 are absorbed in the scintillator 9, the greater part of the high-energy x-ray photons pass through the scintillator 9 and the photodiode detector 11. The high-energy x-ray photons 4 are also transmitted through an x-ray filter 12. The high-energy x-ray photons that form the hard (penetrating) part of the x-ray pulses are absorbed in a scintillator 13 and converted into optical photons 14 that are detected by a photodiode detector 15. Like the photodiode detector 11, the photodiode detector 15 is a detector In which a plurality of photodiodes made from amorphous silicon are arranged next to one another.

The x-ray filter 12 can be a foil or a thin plate made of copper or aluminum.

Standard materials that are known to those skilled in the art can be used for the scintillators 9 and 13, They can be formed, respectively, of different materials or identical materials, In the latter case, the different absorption properties of the scintillators 9 and 13 are achieved by different thicknesses of the respective scintillator,

With the x-ray apparatus 1 shown in FIG. 1, dual simultaneous x-ray exposures can be obtained in more than one energy range. Since the x-ray pulse 3 emitted by the x-ray source 2 leads to simultaneous exposure (irradiation) of the photodiode detectors 11 and 15, two images of the structure of the subject 6 are simultaneously acquired that are respectively associated with different x-ray energy ranges. The soft radiation portion (formed by the low-energy x-ray photons 5) of the x-ray pulse 3 is detected by the photodiode detector 11, and the hard radiation portion (formed by the high-energy x-ray photons 4) of the radiation pulse 3 is detected by the photodiode detector 15. Since both images are acquired simultaneously, the movement of the subject 6 plays no role. The exposures can be subtracted from one another in order to create a high-contrast image of soft tissue parts of the patient.

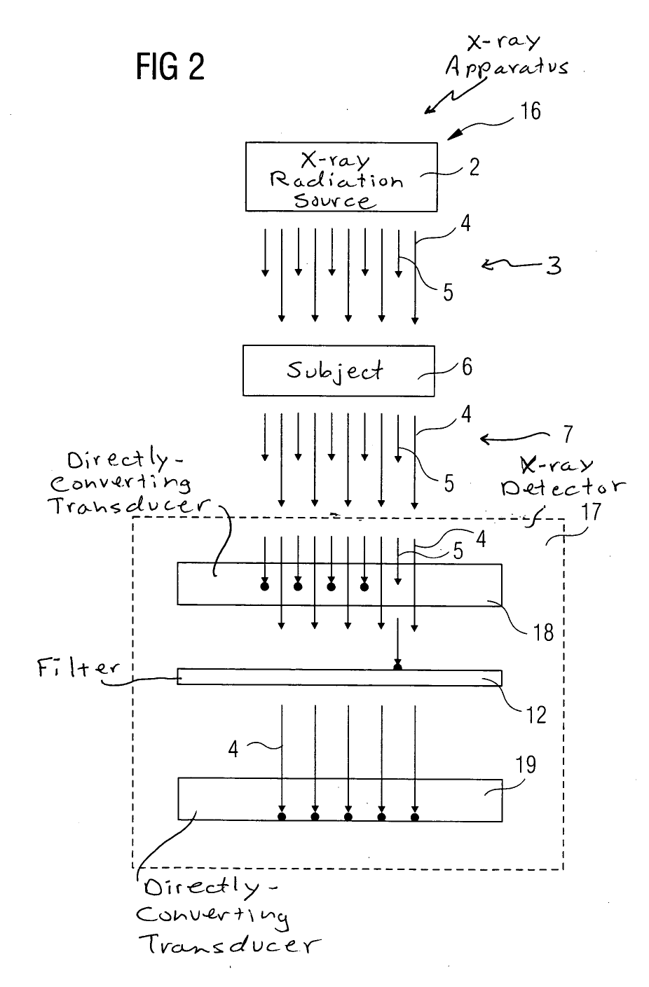

A further exemplary embodiment of an energy-selective x-ray detector is shown in FIG. 2. FIG. 2 shows an x-ray system 16 that has two scintillators 15 and 19 arranged in front of a photodiode detector 17. The scintillators 18 and 19 are provided such that the low-energy x-ray photons 5 are for the most part absorbed in the scintillator 18 and the high-energy x-ray photons 4 are for the most part absorbed in the subsequently arranged scintillator 19. The light formed by the emitted optical photons 20 can be associated with characteristic colors for the respective scintillator 18 or 19. The photodiode detector 17 has different detector regions that react differently to different wavelengths of the detected light.

FIG. 3 shows a view from the front of the photodiode detector 17. The photodiode detector 17 has a series of photodiode lines 21 that alternately react to light from the first scintillator 18 and the second scintillator 19. In order to generate such a wavelength dependency across the image surface of the photodiode detector 17, a suitable optical filter is arranged in front of each photodiode line 21 of the photodiode detector 17.

As shown in FIG. 4, the filters can also be arranged like a checkerboard, such that the spectral sensitivity of adjacent image points 22 differs.

The exemplary embodiment of the x-ray detector 16 shown using FIGS. 2 through 4 offers the advantage that only one photodiode detector 17 is necessary for the simultaneous acquisition of two images in different energy ranges.

In FIG. 5, a further photodiode detector 23 is shown that can be used when sufficient space exists. The x-ray detector 23 has an input-side scintillator 24, behind which a mirror 25 is disposed on the beam path for reflecting light in the optical excitation light range. By means of the mirror 25, the optical photons 10 generated by the scintillator 24 are deflected in a lateral direction to the photodiode detector 26. In contrast to this, the high-energy x-ray photons 4 are transmitted through the mirror 25 and strike on a scintillator 27, The optical photons 14 emitted by the scintillator 27 ultimately arrive at a photodiode detector 28 and are detected there.

As for the x-ray detector 8 specified using FIG. 1, the exemplary embodiments of the x-ray detector specified using FIGS. 2 through 5 are suited for simultaneous acquisition of images at different energies. The occurrence of artifacts as in the prior art Is not a concern when the exposures are subtracted from one another, because both exposures ensue simultaneously, without a delay therebetween, Complex image processing to compensate the unavoidable motion of the patient is not needed.

The apparatuses specified using FIGS. 1 through 5 are particularly suited for examination of soft tissue parts with the aid of x-ray radiation. The bone structures in the body of a patient absorb x-rays substantially independently of their energy, such that the bone structure in both images appears with approximately the same brightness values. For further processing, the acquired Image information is digitized, and the image data are subjected to image processing in which, in the simplest case, the brightness values of one image are subtracted pixel-by-pixel from the brightness values of the other image. The image acquired in this manner essentially reproduces the structure of the soft tissue parts, as well as tissue parts that are obscured by the bone structure.

Although modifications and changes may be suggested by those skilled in the art, it is the intention of the inventors to embody within the patent warranted hereon all changes and modifications as reasonably and properly come within the scope of their contribution to the art.

1. An apparatus for acquiring images from high-energy photons proceeding in a beam path comprising:
first and second transducers, respectively having first and spectral distributions, disposed in said beam path for differently interacting with said high-energy photons in different high-energy ranges, for transmitting photons in a lower of said energy ranges; and
a detector on which said photons in said lower of said energy ranges are incident, said detector having a plurality of first detector regions tuned to said first spectral distribution and a plurality of second detector regions tuned to said second spectral distribution, said detector simultaneously generating a first image from photons incident on said plurality of first detector regions and a second image from photons incident on said second plurality of detector regions,

2. An apparatus as claimed in claim 1 wherein said plurality of first detector regions alternate in stripes with said plurality of second detector regions.

3. An apparatus as claimed in claim 1 wherein said plurality of first detector regions in said plurality of second detector regions form a checkerboard pattern.

4. An apparatus as claimed in claim 1 wherein said first and second transducers are transducers adapted for interacting with x-ray photons.

5. An apparatus as claimed in claim 1 wherein said first and second transducers are adapted for transmitting said photons in said lower of said energy ranges as photons in a optical wavelength range.

6. An apparatus as claimed in claim 1 wherein said first and second transducers comprise first and second scintillators.
